(19) United States
(12) Patent Application Publication
(10) Pub. No.: US 2025/0309440 A1
(43) Pub. Date: Oct. 2, 2025

(54) BATTERY MODULE AND CORRUGATED PLATE SPRING

(71) Applicant: HONDA MOTOR CO., LTD., Tokyo (JP)

(72) Inventor: Hidemasa USUI, Saitama (JP)

(21) Appl. No.: 19/064,734

(22) Filed: Feb. 27, 2025

(30) Foreign Application Priority Data
Mar. 29, 2024 (JP) 2024-056114

(51) Int. Cl. H01M 50/242; H01M 50/204; H01M 50/291; H01M 50/293

(52) U.S. Cl. CPC H01M 50/242; H01M 50/204; H01M 50/291; H01M 50/293

(57) ABSTRACT

Provided is a battery module including a battery cell stack in which a plurality of battery cells are stacked, a pair of plate members provided at opposite ends of the battery cell stack in a stacking direction, and a cushioning material disposed between the plurality of battery cells and/or between the battery cell stack and each of the plate members. The cushioning material includes a corrugated plate spring including concave portions and convex portions that are alternately and continuously arranged, and extending in a predetermined direction. The corrugated plate spring includes a laminate structure in which a layer containing glass fiber and a layer containing epoxy resin are alternately laminated in a thickness direction, and a layer containing a styrene block copolymer or a cycloolefin polymer is present between the layers laminated.

This application is based on and claims the benefit of priority from Japanese Patent Application No. 2024-056114, filed on 29 Mar. 2024, the content of which is incorporated herein by reference.

### BACKGROUND OF THE INVENTION

### Field of the Invention

The present invention relates to a battery module and a corrugated plate spring.

Related Art

In recent years, research and development of battery modules that contribute to energy efficiency has been carried out in order to ensure many people have access to reasonable, reliable, sustainable, and advanced energy.

A battery module includes, for example, a battery cell stack in which a plurality of battery cells are stacked. Here, because each battery cell expands and contracts with charging and discharging, the battery module includes, for example, a pair of end plates provided at opposite ends of the battery cell stack in a stacking direction, and a bind bar that binds the battery cell stack between the pair of end plates.

Japanese Unexamined Patent Application, Publication No. 2022-156427 describes a power storage device including a power storage module including a plurality of power storage cells stacked in a stacking direction, a housing case housing the power storage module, and a restriction unit disposed between the power storage cells. This restriction unit includes a first flat plate and a second flat plate that are spaced apart in the stacking direction, and a corrugated plate disposed between the first flat plate and the second flat plate.

Patent Document 1: Japanese Unexamined Patent Application, Publication No. 2022-156427

### SUMMARY OF THE INVENTION

In a power storage device described in Japanese Unexamined Patent Application, Publication No. 2022-156427, however, when a restriction unit is compressed due to expansion of power storage cells during charging, a difference in surface pressure increases between portions of first and second flat plates in contact with a corrugated plate and portions of the first and second flat plates that are not in contact with the corrugated plate increases, which reduces uniformity of the surface pressure in the restriction unit.

Furthermore, in a case where a corrugated plate made of glass fiber reinforced epoxy resin is applied to the power storage device described in Japanese Unexamined Patent Application, Publication No. 2022-156427, when the restriction unit is compressed due to the expansion of the power storage cells during charging, breakage is caused between glass fiber and epoxy resin that constitute the corrugated plate, or the epoxy resin breaks, which lowers strength of the restriction unit.

An object of the present invention is to provide a battery module capable of increasing a uniformity of surface pressure and a strength in a cushioning material.

(1) A battery module includes: a battery cell stack in which a plurality of battery cells are stacked; a pair of plate members provided at opposite ends of the battery cell stack in a stacking direction; and a cushioning material disposed between the plurality of battery cells and/or between the battery cell stack and each of the plate members. The cushioning material includes a corrugated plate spring including concave portions and convex portions that are alternately and continuously arranged, and extends in a predetermined direction. The corrugated plate spring includes a laminate structure in which a layer containing glass fiber and a layer containing epoxy resin are alternately laminated in a thickness direction, or a laminate structure in which layers containing glass fiber and/or epoxy resin are laminated in the thickness direction, and a layer containing a styrene block copolymer or a cycloolefin polymer is present between the layers laminated.

(2) In the cushioning material of the battery module according to (1), a plurality of the corrugated plate springs are stacked in layers in the stacking direction of the battery cell stack, and the corrugated plate springs adjacent to each other have the concave portions and the convex portions in opposing contact with each other.

(3) In the battery module according to (1) or (2), each of the battery cells is a solid-state battery cell.

(4) A corrugated plate spring includes concave portions and convex portions that are alternately and continuously arranged, and extending in a predetermined direction, the corrugated plate spring including a laminate structure in which a layer containing glass fiber and a layer containing epoxy resin are alternately laminated in a thickness direction, or a laminate structure in which layers containing glass fiber and/or epoxy resin are laminated in the thickness direction, and a layer containing a styrene block copolymer or a cycloolefin polymer is present between the layers laminated.

According to the present invention, a battery module capable of increasing a uniformity of surface pressure and a strength in a cushioning material can be provided.

### BRIEF DESCRIPTION OF THE DRAWINGS

FIG. 1 is a cross-sectional view showing a battery module according to one embodiment of the present invention;

FIG. 2 is a partially enlarged view of the battery module of FIG. 1;

FIG. 3 is an enlarged view of a corrugated plate spring of FIG. 2;

FIG. 4 is a partially enlarged view of the corrugated plate spring of FIG. 3;

FIG. 5 is a partially enlarged view of a modification of the corrugated plate spring of FIG. 3;

FIG. 6 is a graph showing a relation of Young's modulus to allowable strain of a test piece in Example 1 and Comparative Example 1; and

FIG. 7 is a graph showing measurement results of impact reaction force of the test piece in Example 1 and Comparative Example 1.

### DETAILED DESCRIPTION OF THE INVENTION

Hereinafter, embodiments of the present invention will be described with reference to the drawings.

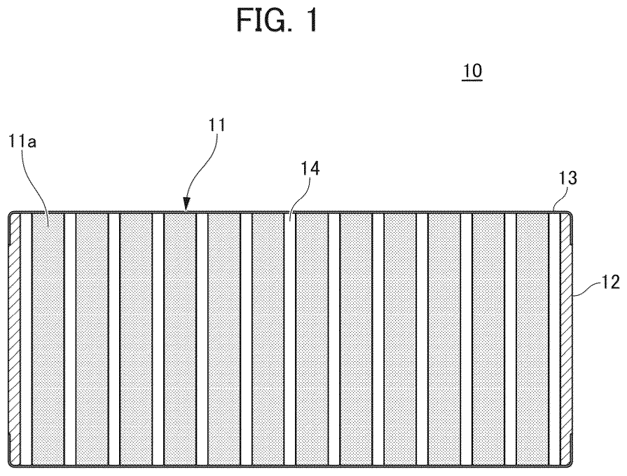

FIG. 1 shows a battery module according to one embodiment of the present invention.

A battery module 10 includes a battery cell stack 11 in which a plurality of battery cells 11a are stacked, end plates 12 as a pair of plate members provided at opposite ends of the battery cell stack 11 in a stacking direction, and bind bars 13 as binding members that bind the battery cell stack 11 between the pair of end plates 12. Here, the bind bars 13 are installed at two locations of upper and lower parts in the drawing, respectively.

In the battery module 10, cushioning materials 14 are arranged between the plurality of battery cells 11a and between the battery cell stack 11 and each of the end plates 12, respectively.

Note that the cushioning material 14 may be disposed between the plurality of battery cells 11a or between the battery cell stack 11 and the end plate 12.

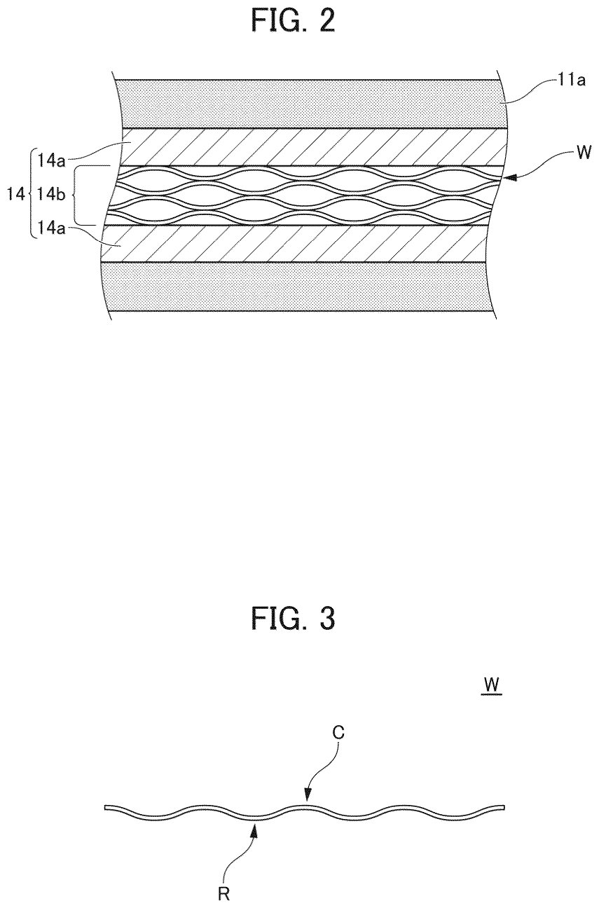

As shown in FIG. 2, a cushioning material 14 includes a pair of first elastic members 14a arranged on opposite outer sides of the battery cell stack 11 in the stacking direction, and a second elastic member 14b disposed between the pair of first elastic members 14a. Furthermore, in the second elastic member 14b, corrugated plate springs W are stacked in four layers in the stacking direction of the battery cell stack 11. Consequently, hysteresis loss of the cushioning material 14 is reduced.

Here, when the cushioning material 14 is compressed due to expansion of the battery cells 11a during charging, the first elastic member 14a is interposed between the battery cell 11a and the second elastic member 14b, and hence a difference in surface pressure decreases between a portion of the first elastic member 14a in contact with the second elastic member 14b and a portion of the first elastic member 14a that is not in contact with the second elastic member 14b, which increases uniformity of the surface pressure.

As shown in FIG. 3, the corrugated plate spring W has a concave portion R and a convex portion C that are alternately and continuously arranged and extends in a direction of depth in the drawing. Furthermore, in the second elastic member 14b, concave portions R and convex portions C of adjacent corrugated plate springs W are in opposing contact with each other. In addition, the concave portion R and the convex portion C protrude downward and upward in the stacking direction of the battery cell stack 11, respectively.

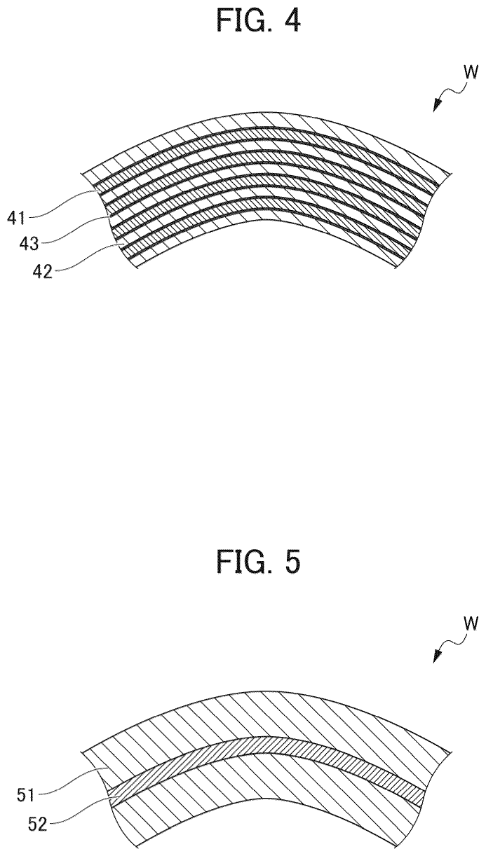

As shown in FIG. 4, the corrugated plate spring W includes a laminate structure in which a first layer 41 containing glass fiber and a second layer 42 containing epoxy resin are alternately laminated in a thickness direction, and between the first layer 41 and the second layer 42 that are laminated, a third layer 43 containing a styrene block copolymer or a cycloolefin polymer is present. This styrene block copolymer or the cycloolefin polymer has high adhesion and flexibility to glass fiber and epoxy resin, so that when the cushioning material 14 is compressed as the battery cell 11a expands during charging, the cushioning material is unlikely to break between the first layer 41 and the second layer 42 that constitute the corrugated plate spring W, and in addition, the second layer 42 is unlikely to break, which increases strength of the cushioning material 14. The corrugated plate spring W is produced, for example, by a press molding method.

The first layer 41 containing glass fiber is not particularly limited, and a woven fabric composed of threads made of glass fiber may be used, for example. The glass fiber may be surface treated with a silane coupling agent. Thus, the strength of the cushioning material 14 further increases.

The epoxy resin contained in the second layer 42 is not particularly limited, and examples thereof include bisphenol A.

A mass ratio of the glass fiber to the epoxy resin in the corrugated plate spring W is not particularly limited, and is, for example, 20% or more and 80% or less.

Examples of the styrene block copolymer contained in the third layer 43 are not particularly limited, and examples thereof include styrene-isoprene-styrene block copolymer (SIS), styrene-ethylene-propylene-styrene block copolymer (SEPS), and styrene-ethylene-butylene-styrene block copolymer (SEBS). Among these examples, a copolymer including a block structure of polystyrene and polyisoprene is preferable.

The cycloolefin polymer contained in the third layer 43 may be either a single polymer or a copolymer and is not particularly limited.

A content of the styrene block copolymer or cycloolefin polymer in the corrugated plate spring W is not particularly limited, and is, for example, 0.3% by mass or more and 15% by mass or less.

The corrugated plate spring W is obtained, for example, by laminating prepregs obtained by impregnating a woven fabric composed of threads made of glass fiber into a liquid obtained by mixing bisphenol A and a styrene block copolymer or cycloolefin polymer in a solvent and then removing the solvent, and then pressing a laminate of prepregs.

Here, the number of laminated first layers 41 is not particularly limited, and is, for example, 2 or more and 80 or less.

As shown in FIG. 5, the corrugated plate spring W includes a laminate structure in which first layers 51 containing glass fiber and epoxy resin are laminated in a thickness direction, and between the laminated first layers 51, a second layer 52 containing a styrene block copolymer or cycloolefin polymer may be present.

Each first layer 51 containing glass fiber and epoxy resin is not particularly limited and, for example, a prepreg may be used. The styrene block copolymer or cycloolefin polymer contained in the second layer 52 is the same as in the third layer 43.

Here, the number of the laminated first layers 51 is not particularly limited, and is, for example, 2 or more and 80 or less.

A method of fixing the second elastic member 14b to the first elastic member 14a is not particularly limited and is, for example, a method of bonding the second elastic member 14b to the first elastic member 14a with an elastic adhesive.

The number of stacked corrugated plate springs W is not limited to 4, and is preferably 2 or more and 6 or less, and further preferably 2 or more and 4 or less.

Furthermore, in the adjacent corrugated plate springs W, a part of the concave portion R and convex portion C that are in opposing contact with each other may be bonded, for example, with an elastic adhesive.

Furthermore, as the second elastic member 14b, the corrugated plate spring W may be used.

The first elastic member 14a preferably has Poisson's ratio of 0.3 or less. If the Poisson's ratio of the first elastic member 14a is 0.3 or less, the first elastic member 14a easily absorbs a change in thickness due to expansion and contraction of the battery cell 11a. The Poisson's ratio of the first elastic member 14a is, for example, 0 or more. The thickness of the first elastic member 14a when the battery cell 11a has a charging rate of 100% is not particularly limited, and is, for example, 0.05 mm or more and 0.1 mm or less.

The first elastic member 14a is, for example, a foam having a porosity of 30% or more and 95% or less. A material constituting the foam is not particularly limited, and examples thereof include polyurethane, silicone resin, ethylene propylene rubber, styrene resin, olefin resin, polyamide, and polyester.

The second elastic member 14b preferably has Young's modulus of 35 GPa or more. If the Young's modulus of the second elastic member 14b is 35 GPa or more, the second elastic member 14b easily absorbs changes in thickness due to the expansion and contraction of the battery cell 11a. The Young's modulus of the second elastic member 14b is, for example, 200 GPa or less.

The thickness of the second elastic member 14b when the charging rate of the battery cell 11a is 100% is not particularly limited, and is, for example, 1.0 mm or more and 1.2 mm or less.

The battery cell 11a is not particularly limited, and examples thereof include solid-state battery cells such as an all-solid-state lithium metal battery cell and a semi-solid-state lithium metal battery cell, and an electrolytic battery cell such as a lithium metal battery cell. Among these examples, the solid-state battery cell is preferable.

Hereinafter, a case in which the battery cell 11a is an all-solid-state lithium metal battery cell will be described.

In the all-solid-state lithium metal battery cell, for example, a positive electrode current collector, a positive electrode composite layer, a solid electrolyte layer, a lithium metal layer, and a negative electrode current collector are sequentially laminated.

The positive electrode current collector is not particularly limited and is, for example, an aluminum foil.

The positive electrode composite layer includes a positive electrode active material and may further include a solid electrolyte, a conductive aid, a binder, or the like.

The positive electrode active material is not particularly limited if lithium ions can be absorbed and released, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCo₄, LiMn₂O₄, LiNiO₂, LiFePO₄, lithium sulfide, and sulfur.

The solid electrolyte constituting the solid electrolyte layer is not particularly limited if this material can conduct lithium ions, and examples thereof include an oxide-based electrolyte and a sulfide-based electrolyte.

The negative electrode current collector is not particularly limited and is, for example, a copper foil.

As above, although embodiments of the present invention have been described, the present invention is not limited to the above embodiments, and the above embodiments may be appropriately altered within the meaning of the present invention.

### EXAMPLES

Hereinafter, examples of the present invention will be described, but the present invention is not limited to the examples. In the present example, an allowable strain, Young's modulus, and impact reaction force were evaluated using a strip-shaped test piece imitating the corrugated plate spring W (see FIG. 4).

### Example 1

A strip-shaped test piece was prepared in which a satin fabric composed of threads made of glass fibers having a fiber diameter of 7 μm as the first layer 41 and bisphenol A as the second layer 42 were alternately laminated via Quintac styrene block copolymer (manufactured by Zeon Corporation, Japan) as the third layer 43. At that time, a direction of warp threads constituting the satin fabric was a longitudinal direction of a strip. Specifically, first, the satin fabric was impregnated into a liquid obtained by mixing bisphenol A and Quintac styrene block copolymer (manufactured by Zeon Corporation, Japan) in a solvent and removing the solvent, to obtain a prepreg. Here, the Quintac styrene block copolymer has a block structure of polystyrene and polyisoprene. Next, the prepreg was laminated and then pressed, to obtain the strip-shaped test piece. At that time, a content of the styrene block copolymer in the test piece was 10% by mass. In addition, a mass ratio of glass fiber to bisphenol A in the test piece was 69%.

### Comparative Example 1

A strip-shaped test piece was obtained in the same manner as in Example 1, except that Quintac styrene block copolymer (manufactured by Zeon Corporation, Japan) was not used. At this time, a mass ratio of glass fiber to bisphenol A in the test piece was set to 69%.

### Allowable Strain

In accordance with JIS K7161, a tensile test was performed to measure an allowable strain of each test piece.

### Young's Modulus

In accordance with JIS K7171, a three-point bending test was performed to measure Young's modulus of the test piece. At that time, a pressurizing direction in the three-point bending test was a direction perpendicular to a direction of warp and weft threads constituting the test piece.

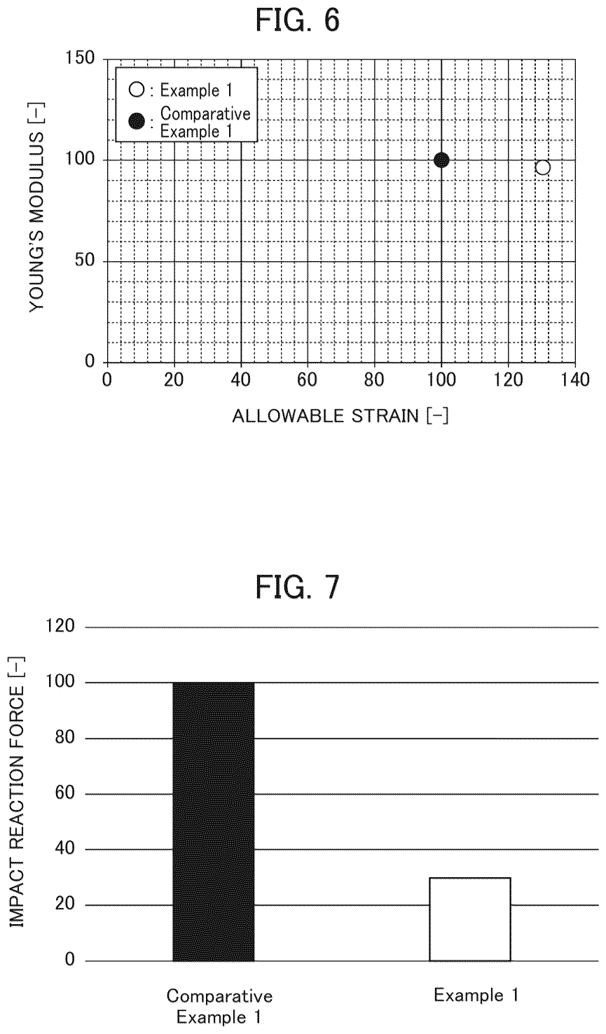

FIG. 6 shows a relation of the Young's modulus to the allowable strain of the test piece in Example 1 and Comparative Example 1. Here, the allowable strain and Young's modulus of Comparative Example 1 were normalized to 100.

It is seen from FIG. 6 that the test piece of Example 1 has an increased allowable strain with little or no decrease in Young's modulus as compared with the test piece of Comparative Example 1. As a result, when the cushioning material 14 is compressed, the material is unlikely to break between the first layer 41 and the second layer 42 that constitute the corrugated plate spring W.

### Impact Reaction Force

In accordance with JIS K7124-1, an impact test was performed to measure an impact reaction force of the test piece. Here, the impact reaction force of Comparative Example 1 was normalized to 100.

FIG. 7 is a graph showing the measurement results of the impact reaction force of the test piece in Example 1 and Comparative Example 1.

It is seen from FIG. 7 that the test piece of Example 1 has a decreased impact reaction force and an increased shock absorption power as compared with the test piece of Comparative Example 1. As a result, when the cushioning material 14 is compressed, the material is unlikely to break between the first layer 41 and the second layer 42 that constitute the corrugated plate spring W.

### EXPLANATION OF REFERENCE NUMERALS

battery module
11 battery cell stack
11a battery cell
12 end plate
13 bind bar
14 cushioning material
14a first elastic member
14b second elastic member
41, 51 first layer
42, 52 second layer
43 third layer
W corrugated plate spring
R concave portion
C convex portion

What is claimed is:

1. A battery module comprising:
a battery cell stack in which a plurality of battery cells are stacked,
a pair of plate members provided at opposite ends of the battery cell stack in a stacking direction, and
a cushioning material disposed between the plurality of battery cells and/or between the battery cell stack and each of the plate members,
the cushioning material including a corrugated plate spring including concave portions and convex portions that are alternately and continuously arranged, and extending in a predetermined direction,
the corrugated plate spring including a laminate structure in which a layer containing glass fiber and a layer containing epoxy resin are alternately laminated in a thickness direction, or a laminate structure in which layers containing glass fiber and/or epoxy resin are laminated in the thickness direction, wherein a layer containing a styrene block copolymer or a cycloolefin polymer is present between the layers laminated.

2. The battery module according to claim 1, wherein
in the cushioning material, a plurality of the corrugated plate springs are stacked in layers in the stacking direction of the battery cell stack, and the corrugated plate springs adjacent to each other have the concave portions and the convex portions in opposing contact with each other.

3. The battery module according to claim 1, wherein
each of the battery cells is a solid-state battery cell.

4. A corrugated plate spring comprising concave portions and convex portions that are alternately and continuously arranged, and extending in a predetermined direction,
the corrugated plate spring comprising a laminate structure in which a layer containing glass fiber and a layer containing epoxy resin are alternately laminated in a thickness direction, or a laminate structure in which layers containing glass fiber and/or epoxy resin are laminated in the thickness direction, wherein a layer containing a styrene block copolymer or a cycloolefin polymer is present between the layers laminated.
